(19) United States
(12) Patent Application Publication
(10) Pub. No.: US 2026/0328988 A1
(43) Pub. Date: Oct. 22, 2026

(54) CERAMIC MATERIAL, OPTICAL MEMBER, HEAD MOUNTED DISPLAY, AND PRODUCTION METHOD

(71) Applicant: AGC Inc., Tokyo (JP)

(72) Inventor: Yoshiki YAMAZAKI, Tokyo (JP)

(73) Assignee: AGC Inc., Tokyo (JP)

(21) Appl. No.: 19/465,606

(22) Filed: Jan. 30, 2026

Related U.S. Application Data
(63) Continuation of application No. PCT/JP2024/028503, filed on Aug. 8, 2024.

(30) Foreign Application Priority Data
Aug. 8, 2023 (JP) 2023-129299

(51) Int. Cl. F21V 8/00; G02B 27/01

(52) U.S. Cl. CPC G02B 6/0065; G02B 27/0172

(57) ABSTRACT

Visible light is transmitted while being appropriately refracted. A ceramic material (10) includes, as a main component, a compound having a perovskite structure represented by the chemical formula A(B1ᵥ, B2₁₋ᵥ)O_{w}, in which A is at least one or more selected from Ba, Sr, Ca, K, Na, La, Gd, and Yb, B1 is at least one or more selected from Ti and Hf, B2 is at least one or more selected from Ta, Nb, Zr, Ge, Gd, Yb, Ga, Ca, and Al, the perovskite structure does not have Mg, Zn, Y, and In, v is a positive number less than 1, and w is a numerical value in which the charge neutrality of the entire chemical formula is established.

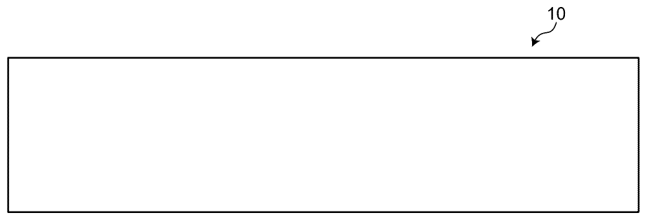

### CROSS-REFERENCE TO RELATED APPLICATION(S)

This application is a continuation of International Application No. PCT/JP2024/028503, filed on Aug. 8, 2024 which claims the benefit of priority of the prior Japanese Patent Application No. 2023-129299, filed on Aug. 8, 2023, the entire contents of which are incorporated herein by reference.

### BACKGROUND OF THE INVENTION

### 1. Field of the Invention

The present invention relates to a ceramic material, an optical member, a head mounted display, and a production method.

### 2. Description of the Related Art

In recent years, materials having a high refractive index and a high transmittance have been required. In particular, for example, in a wearable device such as a head mounted display that realizes augmented reality (AR), virtual reality (VR), mixed reality (MR), and the like as disclosed in WO 2022/234782 A, a high refractive index property and a high transmittance property to visible light as a light guide plate are required.

JP 4747892 B2 describes a translucent ceramic including a perovskite compound as a main component.

However, there is room for improvement in transmitting visible light while appropriately refracting the visible light.

### SUMMARY OF THE INVENTION

It is an object of the present invention to at least partially solve the problems in the conventional technology.

A ceramic material of the present disclosure comprises, as a main component, a compound having a perovskite structure represented by a chemical formula A(B1ᵥ, B2₁₋ᵥ)O_{w}, wherein the A is at least one or more selected from Ba, Sr, Ca, K, Na, La, Gd, and Yb, the B1 is at least one or more selected from Ti and Hf, the B2 is at least one or more selected from Ta, Nb, Zr, Ge, Gd, Yb, Ga, Ca, and Al, the perovskite structure does not have Mg, Zn, Y, and In, v is a positive number less than 1, and w is a numerical value in which a charge neutrality of an entire chemical formula is established.

A ceramic material of the present disclosure comprises, as a main component, a compound having a perovskite structure represented by a chemical formula A(B1ᵥ, B3₁₋ᵥ)O_{w}, wherein the A is at least one or more selected from Ba, Sr, Ca, La, K, Na, Gd, and Yb, the B1 is at least one or more selected from Ti, Hf, Ge, and Zr, the B3 is at least one or more selected from Sc, Y, Zn, Yb, and Al, the perovskite structure does not have Ta and Nb, v is a positive number less than 1, and w is a numerical value in which a charge neutrality of an entire chemical formula is established.

A ceramic material of the present disclosure comprises, as a main component, a compound having a perovskite structure represented by a chemical formula A(Tiₓ, B5ᵥ, B4₁₋ᵥ₋ₓ)O_{w}, wherein the A is at least one or more selected from Ba, Sr, Ca, K, Na, La, Gd, and Yb, the B5 is at least one or more selected from Hf, Ge, and Zr, the B4 is at least one or more selected from Ta, Nb, Al, Sc, Y, and Zn, x is 0.7 or more and 1.0 or less, v is 0 or more and 0.3 or less, x+v≤1.0, and w is a numerical value in which a charge neutrality of an entire chemical formula is established, and the ceramic material has a converted internal transmittance at a thickness of 1 mm with respect to light having a wavelength of 635 nm of 5% or more.

A ceramic material of the present disclosure comprises, as a main component, a compound having a perovskite structure represented by a chemical formula A0(B1ᵥ, B4₁₋ᵥ)O_{w}, wherein the A0 includes Sr and includes at least one of K, Na, La, Gd, and Yb, the B1 is at least one or more selected from Ti, Hf, Ge, and Zr, the B4 is at least one or more selected from Ta, Nb, Al, Sc, Y, and Zn, v is a positive number less than 1, and w is a numerical value in which a charge neutrality of an entire chemical formula is established.

An optical member of the present disclosure comprises the ceramic material as a light guide plate.

A head mounted display of the present disclosure comprises the ceramic material as a light guide plate member.

A production method of the present disclosure produces the ceramic material by a green compact molding method or a cast molding method.

A production method of the present disclosure produces a transparent ceramic body having a refractive index at a wavelength of 635 nm of 2.30 or more by a green compact molding method or a cast molding method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWING

The FIGURE is a schematic view of a ceramic material according to the present embodiment.

### DETAILED DESCRIPTION OF THE PREFERRED EMBODIMENTS

Hereinafter, preferred embodiments of the present invention will be described in detail with reference to the accompanying drawings. The present invention is not limited by the embodiments, and in a case where there are a plurality of embodiments, the present invention includes a combination of the embodiments. The numerical value includes a range of rounding.

### First Embodiment

### Ceramic Material

The FIGURE is a schematic view of a ceramic material according to the present embodiment. The ceramic material 10 according to the present embodiment is a translucent member capable of transmitting visible light. The ceramic material 10 is preferably a polycrystalline ceramic, and it can also be said that the ceramic material 10 is preferably a polycrystalline ceramic sintered body.

As shown in the FIGURE, the ceramic material 10 according to the present embodiment is a plate-like member, but the shape of the ceramic material 10 is not limited to a plate and the ceramic material 10 may have any shape. In the present embodiment, the ceramic material 10 is used as an optical element. More specifically, in the present embodiment, the ceramic material 10 is used as a light guide plate. That is, in the present embodiment, an optical member including the ceramic material 10 as a light guide plate can be provided. Examples of the optical member here include a display device and the like. More specifically, the ceramic material 10 is used as a light guide plate for a head mounted display. The head mounted display is a display device (wearable device) worn on a human head. However, the application of the ceramic material 10 is arbitrary, is not limited to being used as a light guide plate, and is not limited to being used for a head mounted display. For example, as applications of the ceramic material 10, a base substrate for crystal growth, a transparent base material for a capacitive sensor for remote sensing, a low-voltage driving electrostatic induction type panel base material, an optical lens, an ornament/furniture, a mobile terminal/wearable device cover, an interior or non-contact panel cover of a passenger car or the like, a dielectric antenna, a window material for generating a surface microwave plasma, a digital microchannel base material for liquid droplet control, and the like are considered.

### Main Component

The ceramic material 10 includes a compound (oxide) having a perovskite structure as a main component. The ceramic material 10 of the first embodiment includes a compound having a perovskite structure represented by the chemical formula A(B1ᵥ, B2₁₋ᵥ)O_{w}, as a main component. That is, it can be said that the compound as the main component is an oxide in which an element A is located at an A site in the perovskite structure, an element B1 or an element B2 is located at a B site in the perovskite structure, and O is located at an O site in the perovskite structure.

Here, the main component may indicate that the content rate of the component is more than 50% in terms of mass ratio with respect to the entire ceramic material 10. In the ceramic material 10, the content rate of the main component is preferably 90% or more and 100% or less, and more preferably 95% or more and 100% or less in terms of mass ratio with respect to the entire ceramic material 10. The content of the main component can be evaluated by a quantitative analysis method by powder X-ray method.

### Element A

A in A(B1ᵥ, B2_{1-V})O_{w}, is an element located at the A site in the perovskite structure. In the first embodiment, the element A is at least one or more selected from Ba, Sr, Ca, K, Na, La, Gd, and Yb. That is, the element A may include two or more elements of Ba, Sr, Ca, K, Na, La, Gd, and Yb, or may include only one element of Ba, Sr, Ca, K, Na, La, Gd, and Yb. When two or more types of elements are included as the element A, any of these elements is located at the A site of the perovskite structure, and the same applies to the following description of the B site.

The element A preferably includes Sr, and more preferably includes only Sr. However, the element A may include one or more of Ba, Ca, K, Na, La, Yb, and Gd, and Sr. When the element A includes Sr and another element (one or more of Ba, Ca, K, Na, La, and Gd), the content of Sr with respect to the entire element A is preferably 5% or more and 100% or less, more preferably 25% or more and 100% or less, more preferably 50% or more and 100% or less, and still more preferably 75% or more and 100% or less in terms of molar ratio. A high refractive index property and a high transmittance property to visible light can be appropriately secured by setting the content of Sr within this range.

The Sr content can be determined by X-ray fluorescence (XRF). The following method for measuring the content (content in molar ratio) of other elements may also be the same, unless otherwise specified.

### Element B1

B1 in A(B1ᵥ, B2₁₋ᵥ)O_{w} is an element located at the B site in the perovskite structure. In the first embodiment, the element B1 is at least one or more selected from Ti and Hf. That is, the element B1 may include both Ti and Hf elements, or may include only one element of Ti and Hf.

The element B1 preferably includes Ti, and more preferably includes only Ti. However, the element B1 may include Hf and Ti. When the element B1 includes Ti and Hf, the content of Ti with respect to the entire element B1 is preferably more than 70% and 100% or less, more preferably 80% or more and 100% or less, and still more preferably 90% or more and 100% or less in terms of molar ratio. A high refractive index property and a high transmittance property to visible light can be appropriately secured by setting the content of Ti within this range.

### Element B2

B2 in A(B1ᵥ, B2₁₋ᵥ)O_{w} is an element located at the B site in the perovskite structure. In the first embodiment, the element B2 is at least one or more selected from Ta, Nb, Zr, Ge, Gd, Yb, Ga, Ca, and Al. That is, the element B2 may include two or more elements of Ta, Nb, Zr, Ge, Gd, Yb, Ga, Ca, and Al, or may include only one element of Ta, Nb, Zr, Ge, Gd, Yb, Ga, Ca, and Al. The element B2 is preferably at least one or more selected from Zr, Ge, Gd, and Yb, and more preferably at least one or more selected from Zr and Yb.

As described above, in the present embodiment, the element B2 substituted for the element B1 is disposed at a part of the B site. This makes it possible to appropriately secure a high transmittance property while maintaining a high refractive index. That is, for example, when Ti is included in the element B1, a high refractive index can be achieved by Ti, but Ti is likely to be reduced during sintering, and Ti may be colored by reduction, resulting in a decrease in transmittance. In addition, for example, when the element A includes Sr, defects may occur during sintering, resulting in a decrease in transmittance. In response to this, a decrease in transmittance can be prevented, and a high refractive index and a high transmittance property can be secured by substituting a part of the B site with the element B2.

### Numerical Value v

v in A(B1ᵥ, B2₁₋ᵥ)O_{w} is a numerical value indicating a ratio (molar ratio) of the content of the element B1 to the content of the element B2, and more specifically, is a molar ratio of the content of the element B1 to the total content of the element B1 and the element B2. That is, for example, when the element B1 includes only Ti, the numerical value v can be said to be a molar ratio of the content of Ti to the total content of Ti and the element B2. In addition, when the element B1 includes a plurality of types of elements, the content of the element B1 refers to the total content of the plurality of elements, and the same applies to the contents of other elements (the element B2 and other elements described later).

The numerical value v is a positive number less than 1. The numerical value v is preferably set so that the average valence of the element B1 and the element B2 is 4. In other words, the average valence of the element B1 and the element B2 is determined based on the types of the element B1 and the element B2 and the numerical value v. Therefore, it can also be said that the types of the element B1 and the element B2 and the numerical value v are preferably set so that the average valence of the element B1 and the element B2 is 4.

The numerical value v is preferably 0.7 or more and less than 1.0, more preferably 0.8 or more and less than 1.0, and still more preferably 0.9 or more and less than 1.0. When the numerical value v falls within this range, the ratio of the element B1 to the element B2 can be made appropriate, and a high refractive index property and a high transmittance property to visible light can be appropriately secured.

Whether or not a specific element is included in the perovskite crystal can be analyzed by a method such as a peak shift of a diffraction line of an X-ray diffraction method (XRD), a structural analysis such as a Rietveld method, or an X-ray absorption fine structure (EXAFS) analysis.

### Numerical Value w

w in A(B1ᵥ, B2₁₋ᵥ)O_{w} is a numerical value indicating the content (molar ratio) of O, and more specifically, is a molar ratio of the content of O to the total content of the element A, the element B1, the element B2, and O. The numerical value w is a numerical value in which the charge neutrality of the entire chemical formula (A(B1ᵥ, B2_{1-V})O_{w}) is established, and may be, for example, 3.

### Elements Not Contained

The ceramic material 10 according to the first embodiment does not have Mg, Zn, Y, and In in the perovskite structure (a compound having a perovskite structure as a main component). That is, the compound represented by A(B1ᵥ, B2_{1-V})O_{w} does not include any of Mg, Zn, Y, and In at the A site, the B site, and the O site. This makes it possible to secure a high refractive index and a high transmittance property while preventing the complexity of the structure due to an excessive amount of the substitution elements. The ceramic material 10 may have Mg, Zn, Y, and In at locations other than the perovskite structure, or may have Mg, Zn, Y, and In as an inevitable impurity.

### Preferred Examples of Main Component

Preferred examples of the compound represented by A(B1ᵥ, B2₁₋ᵥ)O_{w} in the first embodiment include Sr(Tiᵥ, Ta₁₋ᵥ)O_{w}, Sr (Tiᵥ, Nb₁₋ᵥ)O_{w}, and Sr (Tiᵥ, Al₁₋ᵥ)O_{w}.

### Sub-Component

The ceramic material 10 preferably includes a sub-component that is a component other than the main component mentioned above. The ceramic material 10 preferably includes at least one or more selected from Li, Si, B, and Mg as a sub-component, and more preferably includes Si. This sub-component is derived from a sintering aid in sintering the raw material to sinter the ceramic material 10. The ceramic material 10 may include a sub-component in the form of an oxide of the element listed above.

The content of the sub-component is preferably 50 ppm or more and 50,000 ppm or less, more preferably 50 ppm or more and 20,000 ppm or less, and still more preferably 50 ppm or more and 5,000 ppm or less in terms of mass ratio with respect to the entire ceramic material 10. The ceramic material 10 having a high refractive index and a high transmittance property can be appropriately produced by setting the content of the sub-component within this range.

The content of the sub-component can also be measured by X-ray fluorescence (XRF).

In addition, the ceramic material 10 may include a sub-component other than the above-described sub-component derived from the sintering aid. When a sub-component other than the sub-component derived from the sintering aid is considered as an auxiliary components, the ceramic material 10 preferably includes at least one or more selected from Ce and Pr as an auxiliary component. By including such an auxiliary component, the auxiliary component can function as an oxidizing agent to appropriately receive electrons, and a decrease in transmittance can be more suitably prevented. The ceramic material 10 may include an auxiliary component in the form of an oxide of the element listed above.

The content of the auxiliary component is preferably 50 ppm or more and 50,000 ppm or less, more preferably 50 ppm or more and 20,000 ppm or less, and still more preferably 50 ppm or more and 5,000 ppm or less in terms of mass ratio with respect to the entire ceramic material 10. The ceramic material 10 having a high refractive index and a high transmittance property can be appropriately produced by setting the content of the auxiliary component within this range.

The content of the auxiliary component can also be measured by X-ray fluorescence (XRF).

Note that the ceramic material 10 may contain any component as an inevitable impurity in addition to the main component, the sub-component, and the auxiliary component described above. The ceramic material 10 preferably does not have components other than the main component, the sub-component, and the auxiliary component, except for an inevitable impurity.

### Characteristics of Ceramic Material

Next, characteristics of the ceramic material 10 will be described.

### Refractive Index

The ceramic material 10 preferably has a refractive index with respect to light having a wavelength of 635 nm of 2.25 or more and 2.45 or less, more preferably 2.30 or more, still more preferably 2.30 or more and 2.45 or less, and still more preferably 2.35 or more and 2.45 or less. When the refractive index falls within this range, visible light can be appropriately refracted.

The refractive index can be measured by spectroscopic ellipsometry (J. A. Woollam Co., Inc.; M-2000 DI).

### Transmittance

The ceramic material 10 preferably has a converted internal transmittance at a thickness of 1 mm with respect to light having a wavelength of 635 nm of 5% or more, preferably 10% or more, preferably 15% or more, more preferably 20% or more, more preferably 30% or more, more preferably 40% or more, more preferably 50% or more, more preferably 60% or more, and still more preferably 80% or more. The converted internal transmittance here refers to the internal transmittance in a unit thickness of the ceramic material 10, and is a value obtained by dividing the measured internal transmittance (%) by the thickness (mm) of the ceramic material 10 to be measured. When the internal transmittance falls within this range, visible light can be appropriately transmitted.

Note that the internal transmittance can be calculated in the following procedure using external transmittance measurement values T1 of two plates having different plate thicknesses and reflectance R. The external transmittance means transmittance including surface reflection loss. The converted internal transmittance can be determined as follows. In a case where the refractive index at 635 nm is n, the reflectance on the incident surface is calculated from equation (n−1)²/(n+1)², a value obtained by subtracting a value obtained by doubling the reflectance from 1 is defined as the theoretical transmittance T0, and T2=T1/T0 is defined as the internal transmittance. The apparent absorption coefficient α (cm⁻¹) can be calculated by taking the natural logarithm of the internal transmittance T2, giving a negative sign, and dividing it by the sample thickness (unit: cm). By multiplying the apparent absorption coefficient by 0.1 (cm), giving a negative sign, and taking an index with e as the base, it can be evaluated as the converted internal transmittance T3(%) at a thickness of 1 mm. The external transmittance can be measured using a spectrophotometer (U-4100 manufactured by Hitachi High-Tech Corporation) on a sample having a plate thickness of 0.5 mm to 10 mm whose both surfaces have been mirror-polished.

The converted internal transmittance evaluation may be performed by the following method. When a laser light source having a spot diameter of 2 mm and a wavelength of 635 nm is perpendicularly incident on a polished surface of a mirror-polished parallel flat plate of ceramic, and a Si photodetector is installed at a distance of 20 cm from a sample on a side facing the light source with respect to the sample, an apparent absorption coefficient α′ (cm⁻¹) can be calculated using a transmittance T1′ obtained from a ratio of received light intensity in the Si photodetector to an output of the incident light source by taking the natural logarithm of T2′=T1′/T0, giving a negative sign, and dividing it by the sample thickness (unit: cm). A value obtained as the converted internal transmittance T3′ at a thickness of 1 mm by multiplying the apparent absorption coefficient by 0.1 (cm), giving a negative sign, and taking an index with e as the base can be evaluated as the converted internal transmittance. The polished surface of the sample is sufficiently large with respect to the spot diameter of the laser, and is typically about 1 cm.

The converted internal transmittance is determined according to the composition of the ceramic material 10, but may vary depending on the manufacturing process of the ceramic material 10 even with the same composition. Therefore, for example, the converted internal transmittance can be set to the above range by appropriately adjusting the manufacturing process of the ceramic material 10. Here, a known method such as careful mixing of raw materials can be used as a method for adjusting the manufacturing process. For example, in the element A, the converted internal transmittance can be appropriately set to the above range by setting the ratio of the total content of K, Na, La, Yb, and Gd to the entire element A to, for example, 0.05% or more and 10% or less in terms of molar ratio.

### Fracture Toughness Value

The ceramic material 10 preferably has a fracture toughness value K_{IC} of 1.0 MPa·m^{0.5} or more, more preferably 1.05 MPa·m^{0.5} or more and 2.5 MPa·m^{0.5} or less, more preferably 1.05 MPa·m^{0.5} or more and 2.2 MPa·m^{0.5} or less, more preferably 1.05 MPa·m^{0.5} or more and 2.00 MPa·m^{0.5} or less, more preferably 1.05 MPa·m^{0.5} or more and 1.9 MPa·m^{0.5} or less, still more preferably 1.05 MPa·m^{0.5} or more and 1.80 MPa·m^{0.5} or less. When the fracture toughness value K_{IC} falls within this range, damage to the ceramic material 10 can be prevented. The fracture toughness value K_{IC} can be obtained by, for example, an IF method or an SEPB method in accordance with JIS R1607.

The ratio of the fracture toughness value K_{IC} of the ceramic material 10 to the fracture toughness value K_{IC} of SrTiO₃ of the single crystal material (K_{IC} of the ceramic material 10/K_{IC} of SrTiO₃ of a single crystal) is preferably 1.05 or more, more preferably 1.10 or more and 1.30 or less, still more preferably 1.15 or more and 1.30 or less. When the fracture toughness value K_{IC} falls within this range, damage to the ceramic material 10 can be prevented.

### Vickers Hardness

The Vickers hardness of the ceramic material 10 is preferably 500 HV or more, more preferably 550 HV or more, more preferably 600 HV or more, more preferably 650 HV or more, more preferably 700 HV or more, more preferably 750 HV or more, still more preferably 800 HV or more, and still more preferably 850 HV or more. When the Vickers hardness is within this range, the wear resistance of the ceramic material 10 is improved. The Vickers hardness can be evaluated using a Vickers hardness meter (FV-800) manufactured by FUTURE-TECH CORP. As measurement conditions in this case, a load may be 0.5 kgf and a pressurization time may be 15 seconds. The same conditions may also be used in the fracture toughness evaluation by the IF method.

### Evaluation of Color Tone

Since the present ceramic material contains a large amount of Ti, the ceramic material is easily colored, but the ceramic material is preferably colorless. Therefore, the color tone is evaluated. As a method, a sample whose surface was roughened using #500 sandpaper was irradiated with white light of 100 W, and the color tone of scattered light was visually checked. In the evaluation of the color tone, the ceramic material 10 preferably has a white appearance (color tone of scattered light).

### Method for Producing Ceramic Material

The ceramic material 10 according to the present embodiment may be produced by any method, but an example of the production method will be described below.

### Preparation of Raw Material

In the present production method, a powdery main raw material serving as a raw material of a main component of the ceramic material 10 is prepared as a raw material used for producing the ceramic material 10. The main raw material is a material including an element included in the main component of the ceramic material 10. The main raw material may be any material including an element included in the main component of the ceramic material 10. The main raw material may be, for example, the main component itself of the ceramic material 10. That is, for example, in the present embodiment, the main raw material may be a powder of A(B1ᵥ, B2₁₋ᵥ)O_{w}). The main raw material may also be a plurality of types of materials including some of the elements included in the main component of the ceramic material 10. That is, for example, in the present embodiment, the main raw material may be an oxide of the element A, an oxide of the element B1, and an oxide of the element B2.

When the ceramic material 10 includes a sub-component, a powdery sub-raw material serving as a raw material of the sub-component of the ceramic material 10 is also prepared. The sub-raw material is a material including an element included in the sub-component of the ceramic material 10, and is a so-called sintering aid. The sub-raw material may be any material including an element included in the sub-component of the ceramic material 10. Examples of the sub-raw material include an oxide of an element included in the sub-component (for example, Li₂O, SiO₂, B₂O₃, MgO, and the like), a fluoride of an element included in the sub-component (for example, LiF, MgF₂, and the like), and a carbonate of an element included in the sub-component (for example, Li₂CO₃).

When the ceramic material 10 includes an auxiliary component, a powdery auxiliary raw material serving as a raw material of the auxiliary component of the ceramic material 10 is also prepared. The auxiliary raw material is a material including an element included in the auxiliary component of the ceramic material 10, and is a so-called oxidizing agent. The auxiliary raw material may be any material including an element included in the auxiliary component of the ceramic material 10. Examples of the auxiliary raw material include oxides of elements included in the auxiliary component (for example, CeO₂, Pr₆O₁₁, and the like).

The average particle size of the raw material (main raw material, sub-raw material, and auxiliary raw material) may be arbitrary, but is preferably, for example, 0.03 μm or more and 5.00 μm or less. This makes it possible to appropriately perform sintering. The average particle size can be measured by, for example, a particle size distribution measuring device (Shimadzu Corporation: SALD-2300).

The type and blending ratio of the raw materials may be appropriately set according to the composition of the ceramic material 10 to be produced.

### Mixing of Raw Materials

Next, the prepared raw materials are mixed. A method of mixing the raw materials may be arbitrary, but for example, a ball mill or the like may be used. A solvent may also be added to the raw material and wet-mixed. In this case, for example, a solvent (for example, water or ethanol) and a mixed medium (for example, alumina or zirconia) may be added to the raw material and wet-mixed for a period of 1 hour or more and 5 hours or less. In order to solve the aggregation of the raw material powder, a dispersant may also be added and mixed. In addition, in the case of performing wet mixing, when mixing is completed, a liquid component is removed from the mixed raw material (slurry) by a drying treatment or the like.

When the mixed raw material includes a carbon component, a carbon removal treatment for removing the carbon component may be performed. The carbon removal treatment may be, for example, a treatment in which the mixed raw material is held in a temperature range of 800° C. or more and 1100° C. or less for 1 hour or more and 20 hours or less. The carbon removal treatment may be performed in an air atmosphere or an oxygen atmosphere.

### Molding of Raw Material

Next, the mixed raw materials are molded into a desired shape to obtain a molded body that is a set of raw materials molded into a desired shape. The method for producing the molded body is not particularly limited, but molding by a green compact molding method or a cast molding method is preferable.

### Green Compact Molding Method

In the green compact molding method, for example, a binder (for example, an organic binder such as polyvinyl alcohol) may be added to the mixed raw material to obtain a raw material slurry in which the binder is added to the raw material. In addition to the binder, an organometallic compound or a lactate component may also be added.

Then, the obtained raw material slurry is pressurized and formed into a desired shape. For example, the raw material slurry is molded by uniaxial pressing, and then subjected to a Cold Isostatic Pressing (CIP) treatment under the condition of 125 MPa or more and 175 MPa or less to obtain a molded body.

### Cast Molding Method

For example, the molded body can also be made by a cast molding method. The cast molding includes a flow casting method, a pressure casting method, a drain casting method, and the like.

The pressure casting method is a method in which a pressure is applied to the raw material slurry from below a stacked mold (for example, gypsum) to pour the raw material slurry into the mold, and the raw material slurry is dried without being discarded. The raw material slurry can be obtained by a method similar to the method described in the green compact molding method.

The drain casting method is a method in which the mixed raw material slurry is poured out to a casting mold and the solvent is dried to obtain a molded body. The raw material slurry is obtained by adding a solvent to the mixed raw material. The solvent may be aqueous or non-aqueous, but when the solvent is aqueous, a gypsum mold used as a normal cast mold may degrade optical characteristics due to the possibility that gypsum is dissolved in water and gypsum is mixed into the molded body, and thus it is preferable to use a resin mold or porous ceramics. When a non-aqueous alcohol or the like is used as a solvent, it is preferable to use a gypsum mold. In the present embodiment, it is preferable to use an aqueous solvent. It is desirable to use porous ceramics as the material of the mold. The wall surface of the mold may be made of a mirror-finished glass material or a vinyl chloride material to enhance releasability.

### Degreasing of Molded Body

Next, a degreasing treatment for removing a binder component included in the molded body is performed. In the degreasing treatment, for example, the obtained molded body is heated to 700° C. or higher and 800° C. or lower in an air atmosphere.

### Sintering of Molded Body

Next, the degreased molded body is subjected to a sintering treatment to obtain the ceramic material 10 which is a sintered body of the molded body (raw material). In the sintering treatment, the molded body is heat-treated in an oxygen atmosphere. In this heat treatment, it is preferable to heat the molded body while pressurizing the molded body. For example, the pressure applied to the molded body may be 1 atm or more and 3 atm or less, the heating temperature of the molded body may be 1300° C. or more and 1550° C. or less, and the time for pressurization and heating may be longer than 0 hour and 24 hours or less.

In the sintering treatment, after the heat treatment in the oxygen atmosphere, a hot isostatic pressing (HIP) treatment may be performed in an atmosphere including Ar (for example, under an Ar atmosphere or under a mixed atmosphere of Ar and oxygen). The applied pressure in the HIP treatment may be 100 MPa or more and 200 MPa or less, the heating temperature may be 1250° C. or more and 1450° C. or less, and the time of the HIP treatment may be 1 hour or more and 4 hours or less.

Further, a post-annealing treatment in which the sintered body after the HIP treatment is held at 800° C. or higher and 1400° C. or lower in an air atmosphere or an oxygen atmosphere may be executed. This makes it possible to recover from the reduction state generated by the HIP treatment.

The ceramic material 10 thus obtained by sintering may be subjected to machining such as polishing.

The green compact molding method and the cast molding method described above are not limited to being used for the production of the ceramic material 10 according to the present embodiment. For example, a transparent ceramic body having a refractive index at a wavelength of 635 nm of 2.30 or more may be produced by the green compact molding method or the cast molding method. That is, in this case, a molded body is formed by the green compact molding method and the cast molding method using a raw material of the transparent ceramic body, and the molded body is sintered to produce the transparent ceramic body having a refractive index at a wavelength of 635 nm of 2.30 or more.

As described above, the ceramic material 10 according to the first embodiment includes a compound having a perovskite structure represented by the chemical formula A(B1ᵥ, B2₁₋ᵥ)O_{w}, as a main component, and does not include Mg, Zn, Y, and In in the perovskite structure. The ceramic material 10 of the present embodiment includes a compound having a perovskite structure in which the element A is at the A site and the element B1 is at the B site, and thus has a high refractive index to visible light. In addition, since the ceramic material 10 includes such a compound having a perovskite structure, the ceramic material 10 forms a polycrystalline cubic crystal, and has a high transmittance to visible light. Furthermore, since a part of the B site is substituted with the element B2, a decrease in transmittance can be prevented, and a high refractive index and a high transmittance property can be secured. In addition, since the perovskite structure does not have Mg, Zn, Y, and In, it is possible to secure a high refractive index and a high transmittance property while preventing the complexity of the structure due to an excessive amount of substitution elements.

### Second Embodiment

Next, a second embodiment will be described. In the second embodiment, the composition of the main component included in the ceramic material 10 is different from that of the first embodiment. In the second embodiment, description of parts common to the first embodiment will be omitted.

### Main Component

The ceramic material 10 includes a compound (oxide) having a perovskite structure as a main component. The ceramic material 10 of the second embodiment includes a compound having a perovskite structure represented by the chemical formula A(B1ᵥ, B3₁₋ᵥ)O_{w} as a main component. That is, it can be said that the compound as the main component is an oxide in which the element A is located at the A site in the perovskite structure, the element B1 or B3 is located at the B site in the perovskite structure, and O is located at the O site in the perovskite structure.

Here, the main component may indicate that the content rate of the component is more than 50% in terms of mass ratio with respect to the entire ceramic material 10. In the ceramic material 10, the content rate of the main component is preferably 90% or more and 100% or less, and more preferably 95% or more and 100% or less in terms of mass ratio with respect to the entire ceramic material 10.

### Element A

Since the element A in the second embodiment is the same as the element A in the first embodiment, the description thereof will be omitted.

### Element B1

Since the element B1 in the second embodiment is the same as the element B1 in the first embodiment, the description thereof will be omitted.

### Element B3

B3 in A(B1ᵥ, B3₁₋ᵥ)O_{w} is an element located at the B site in the perovskite structure. In the second embodiment, the element B3 is at least one or more selected from Sc, Y, Zn, Yb, and Al. That is, the element B3 may include two or more elements of Sc, Y, Zn, Yb, and Al, or may include only one element of Sc, Y, Zn, Yb, and Al. The element B3 is preferably at least one or more selected from Zn, Yb, and Al, and more preferably at least one or more selected from Yb and Al.

As described above, in the present embodiment, the element B3 substituted for the element B1 is disposed at a part of the B site. This makes it possible to appropriately secure a high transmittance property while maintaining a high refractive index. That is, for example, when Ti is included in the element B1, a high refractive index can be achieved by Ti, but Ti is likely to be reduced during sintering, and Ti may be colored by reduction, resulting in a decrease in transmittance. In addition, for example, when the element A includes Sr, defects may occur during sintering, resulting in a decrease in transmittance. In response to this, a decrease in transmittance can be prevented, and a high refractive index and a high transmittance property can be secured by substituting a part of the B site with the element B3.

### Numerical Value v

v in A(B1ᵥ, B3₁₋ᵥ)O_{w} is a numerical value indicating a ratio (molar ratio) of the content of the element B1 to the content of the element B3, and more specifically, is a molar ratio of the content of the element B1 to the total content of the element B1 and the element B3. That is, for example, when the element B1 includes only Ti, the numerical value v can be said to be a molar ratio of the content of Ti to the total content of Ti and the element B3.

The numerical value v is a positive number less than 1. The numerical value v is preferably set so that the average valence of the element B1 and the element B3 is 4. It can also be said that the types of the element B1 and the element B3 and the numerical value v are preferably set so that the average valence of the element B1 and the element B3 is 4.

The numerical value v is preferably 0.7 or more and less than 1.0, more preferably 0.8 or more and less than 1.0, and still more preferably 0.9 or more and less than 1.0. When the numerical value v falls within this range, the ratio of the element B1 to the element B3 can be made appropriate, and a high refractive index property and a high transmittance property to visible light can be appropriately secured.

### Numerical Value w

w in A(B1ᵥ, B3₁₋ᵥ)O_{w} is a numerical value indicating the content (molar ratio) of O, and more specifically, is a molar ratio of the content of 0 to the total content of the element A, the element B1, the element B3, and O. The numerical value w is a numerical value in which the charge neutrality of the entire chemical formula (A(B1ᵥ, B3₁₋ᵥ)O_{w}) is established, and may be, for example, 3.

### Elements Not Contained

The ceramic material 10 according to the second embodiment does not have Ta and Nb in the perovskite structure (a compound having a perovskite structure as a main component). That is, the compound represented by A(B1ᵥ, B3₁₋ᵥ)O_{w} does not include any of Ta and Nb at the A site, the B site, and the O site. This makes it possible to secure a high refractive index and a high transmittance property while preventing the complexity of the structure due to an excessive amount of the substitution elements. The ceramic material 10 may have Ta and Nb at locations other than the perovskite structure, or may have Mg, Ta, and Nb as an inevitable impurity.

### Preferred Examples of Main Component

Preferred examples of the compound represented by A(B1ᵥ, B3₁₋ᵥ)O_{w} in the second embodiment include Sr(Tiᵥ, Sc₁₋ᵥ)O_{w}, Sr (Tiᵥ, Y₁₋ᵥ) O_{w}, Sr (Tiᵥ, Zn₁₋ᵥ)O_{w}, and Sr (Tiᵥ, Al₁₋ᵥ)O_{w}.

### Sub-Component

The ceramic material 10 according to the second embodiment also preferably has a sub-component derived from the sintering aid as in the first embodiment. The ceramic material 10 according to the second embodiment also preferably has an auxiliary component as in the first embodiment. Preferred compositions and contents of the sub-component and the auxiliary component are the same as those in the first embodiment, and thus the description thereof will be omitted.

Note that the ceramic material 10 according to the second embodiment may contain any component as an inevitable impurity in addition to the main component, the sub-component, and the auxiliary component described above. The ceramic material 10 according to the second embodiment preferably does not have components other than the main component, the sub-component, and the auxiliary component, except for an inevitable impurity.

### Characteristics of Ceramic Material

Since the characteristics of the ceramic material 10 according to the second embodiment are the same as the characteristics of the ceramic material 10 according to the first embodiment, the description thereof will be omitted.

### Method for Producing Ceramic Material

The ceramic material 10 according to the second embodiment may be produced by any method. An example of the method for producing the ceramic material 10 according to the second embodiment is the same as the example of the method for producing the ceramic material 10 according to the first embodiment, and thus the description thereof will be omitted. However, the second embodiment is different from the first embodiment in that a main raw material including an element B3 instead of the element B2 is prepared.

As described above, the ceramic material 10 according to the second embodiment includes a compound having a perovskite structure represented by the chemical formula A(B1ᵥ, B3₁₋ᵥ)O_{w} as a main component, and does not include Mg, Zn, Y, and In in the perovskite structure. The ceramic material 10 of the present embodiment includes a compound having a perovskite structure in which the element A is at the A site and the element B1 is at the B site, and thus has a high refractive index to visible light. In addition, since the ceramic material 10 includes such a compound having a perovskite structure, the ceramic material 10 forms a polycrystalline cubic crystal, and has a high transmittance to visible light. Furthermore, since a part of the B site is substituted with the element B3, a decrease in transmittance can be prevented, and a high refractive index and a high transmittance property can be secured. In addition, since the perovskite structure does not have Ta and Nb, it is possible to secure a high refractive index and a high transmittance property while preventing the complexity of the structure due to an excessive amount of substitution elements.

### Third Embodiment

Next, a third embodiment will be described. In the third embodiment, the composition of the main component included in the ceramic material 10 is different from that of the first embodiment. In the third embodiment, description of parts common to the first embodiment will be omitted.

### Main Component

The ceramic material 10 includes a compound (oxide) having a perovskite structure as a main component. The ceramic material 10 of the third embodiment includes a compound having a perovskite structure represented by the chemical formula A(Tiₓ, B5ᵥ, B4₁₋ᵥ₋ₓ)O_{w} as a main component. That is, it can be said that the compound as the main component is an oxide in which the element A is located at the A site in the perovskite structure, Ti, the element B5, or the element B4 is located at the B site in the perovskite structure, and O is located at the O site in the perovskite structure.

Here, the main component may indicate that the content rate of the component is more than 50% in terms of mass ratio with respect to the entire ceramic material 10. In the ceramic material 10, the content rate of the main component is preferably 90% or more and 100% or less, and more preferably 95% or more and 100% or less in terms of mass ratio with respect to the entire ceramic material 10.

### Element A

Since the element A in the third embodiment is the same as the element A in the first embodiment, the description thereof will be omitted.

### Element B5

The element B5 in A(Tix, B5ᵥ, B4₁_V_ₓ)O, is at least one or more selected from Hf, Ge, and Zr. That is, the element B5 may include two or more elements of Hf, Ge, and Zr, or may include only one element of Hf, Ge, and Zr.

### Element B4

B4 in A(Tiₓ, B5ᵥ, B4₁₋ᵥ₋ₓ)O_{w} is an element located at the B site in the perovskite structure. In the third embodiment, the element B4 is at least one or more selected from Ta, Nb, Al, Sc, Y, and Zn. That is, the element B4 may include two or more elements of Ta, Nb, Al, Sc, Y, and Zn, or may include only one element of Ta, Nb, Al, Sc, Y, and Zn. The element B4 is preferably at least one or more selected from Ta, Nb, Al, and Zn, and more preferably at least one or more selected from Ta, Nb, and Al.

### Numerical Value v

x in A(Tiₓ, B5ᵥ, B4₁₋ᵥ₋ₓ)O_{w} is a numerical value indicating a ratio (molar ratio) of the content of the Ti element, the content of the element B5, and the content of the element B4, and more specifically, is a molar ratio of the content of the Ti element to the total content of the Ti element, the element B1, and the element B4. v is a numerical value indicating the ratio (molar ratio) of the content of Ti and the element B5 to the content of the element B4, and more specifically, is a molar ratio of the content of the element B5 to the total content of the Ti element, the element B5, and the element B4.

The numerical value x is 0.7 or more and 1.0 or less, preferably 0.8 or more and 1.0 or less, and more preferably 0.9 or more and 1.0 or less. The numerical value v is 0.0 or more and 0.3 or less, preferably 0.0 or more and 0.2 or less, and more preferably 0.0 or more and 0.1 or less. The sum of the numerical value x and the numerical value v is 1.0 or less (x+v≤1.0), preferably 0.99 or less, more preferably 0.97 or less, preferably 0.94 or less, and more preferably 0.90 or less.

When the numerical values x and v fall within these ranges, the ratio of the Ti element, the element B5, and the element B4 can be made appropriate, and a high refractive index property and a high transmittance property to visible light can be appropriately secured. That is, for example, the Ti element at the B site can achieve a high refractive index, but Ti is likely to be reduced during sintering, and Ti may be colored by reduction, resulting in a decrease in transmittance. In addition, for example, the element A may cause defects during sintering, resulting in a decrease in transmittance. In response to this, by setting the molar ratio of the Ti element, the element B5, and the element B4 (numerical values x and v) within the above range while substituting a part of the B site with the element B4, a decrease in transmittance can be prevented, and a high refractive index and a high transmittance property can be secured.

The numerical value v is a positive number less than 1. The numerical value v is preferably set so that the average valence of the element B5 and the element B4 is 4. It can also be said that the types of the element B5 and the element B4 and the numerical value v are preferably set so that the average valence of the element B5 and the element B4 is 4.

### Numerical Value w

w in A(Tiₓ, B5ᵥ, B4₁₋ᵥ₋ₓ)O_{w} is a numerical value indicating the content (molar ratio) of O, and more specifically, is a molar ratio of the content of O to the total content of the element A, the element B5, the element B4, and O. The numerical value w is a numerical value in which the charge neutrality of the entire chemical formula A(Tiₓ, B5ᵥ, B4₁₋ᵥ₋ₓ)O_{w}, is established, and may be, for example, 3.

### Preferred Examples of Main Component

Preferred examples of the compound represented by A(Tiₓ, B5ᵥ, B4₁₋ᵥ₋ₓ)O_{w} in the third embodiment include Sr(Tiₓ, Zrᵥ)O_{w}, Sr(Tiₓ, Geᵥ)O_{w}, Sr(Tiₓ, Hfᵥ)O_{w}, Sr(Tiₓ, Zrᵥ, Ta₁₋ᵥ₋ₓ)O_{w}, Sr(Tiₓ, Zrᵥ, Nb₁₋ᵥ)O_{w}, Sr(Tiₓ, Zrᵥ, Al₁₋ᵥ₋ₓ)O_{w}, Sr(Tiₓ, Zrᵥ, Sc₁₋ᵥ₋ₓ)O_{w}, Sr(Tiₓ, Zrᵥ, Y₁₋ᵥ₋ₓ)O_{w}, Sr(Tiₓ, Zrᵥ, Zn₁₋ᵥ₋ₓ)O_{w}, Sr(Tiₓ, Geᵥ, Ta₁₋ᵥ₋ₓ)O_{w}, Sr(Tiₓ, Geᵥ, Nb₁₋ᵥ)O_{w}, Sr(Tiₓ, Geᵥ, Al₁₋ᵥ₋ₓ)O_{w}, Sr(Tiₓ, Geᵥ, Sc₁₋ᵥ₋ₓ)O_{w}, Sr(Tiₓ, Geᵥ, Y₁₋ᵥ₋ₓ)O_{w}, and Sr(Tiₓ, Geᵥ, Zn₁₋ᵥ₋ₓ)O_{w}.

### Sub-Component

The ceramic material 10 according to the third embodiment also preferably has a sub-component derived from the sintering aid as in the first embodiment. The ceramic material 10 according to the third embodiment also preferably has an auxiliary component as in the first embodiment. Preferred compositions and contents of the sub-component and the auxiliary component are the same as those in the first embodiment, and thus the description thereof will be omitted.

Note that the ceramic material 10 according to the third embodiment may contain any component as an inevitable impurity in addition to the main component, the sub-component, and the auxiliary component described above. The ceramic material 10 according to the third embodiment preferably does not have components other than the main component, the sub-component, and the auxiliary component, except for an inevitable impurity.

### Characteristics of Ceramic Material

Since the characteristics of the ceramic material 10 according to the third embodiment are the same as the characteristics of the ceramic material 10 according to the first embodiment, the description thereof will be omitted. However, the ceramic material 10 according to the third embodiment has a converted internal transmittance with respect to light having a wavelength of 635 nm of 5% or more, preferably 15% or more as an internal transmittance at a thickness of 1 mm.

As described above, the converted internal transmittance is determined according to the composition of the ceramic material 10, but may vary depending on the manufacturing process of the ceramic material 10 even with the same composition. Therefore, for example, the converted internal transmittance can be set to the above range by appropriately adjusting the manufacturing process of the ceramic material 10. Here, a known method such as careful mixing of raw materials can be used as a method for adjusting the manufacturing process. For example, in the element A, the converted internal transmittance can be appropriately set to the above range by setting the ratio of the total content of K, Na, La, Yb, and Gd to the entire element A to, for example, 0.05% or more and 10% or less in terms of molar ratio.

### Method for Producing Ceramic Material

The ceramic material 10 according to the third embodiment may be produced by any method. An example of the method for producing the ceramic material 10 according to the third embodiment is the same as the example of the method for producing the ceramic material 10 according to the first embodiment, and thus the description thereof will be omitted. However, the third embodiment is different from the first embodiment in that a main raw material including an element B4 instead of the element B3 is prepared.

As described above, the ceramic material 10 according to the third embodiment includes, as a main component, a compound having a perovskite structure represented by the chemical formula A(Tiₓ, B5ᵥ, B4₁₋ᵥ₋ₓ)O_{w}, in which x is 0.7 or more and 1.0 or less, v is 0.0 or more and 0.3 or less, and x+v≤1.0, and the ceramic material 10 has a converted internal transmittance at a thickness of 1 mm with respect to light having a wavelength of 635 nm of 5% or more. The ceramic material 10 of the present embodiment includes a compound having a perovskite structure in which the element A is at the A site and the element B1 is at the B site, and thus has a high refractive index to visible light. In addition, since the ceramic material 10 includes such a compound having a perovskite structure, the ceramic material 10 forms a polycrystalline cubic crystal, and has a high transmittance to visible light. Furthermore, by substituting a part of the B site with the element B4, and by setting the ratio of the element B5 to the element B4 (numerical value v) within the above range, a decrease in transmittance can be prevented, and a high refractive index and a high transmittance property can be secured.

### Fourth Embodiment

Next, a fourth embodiment will be described. In the third embodiment, the composition of the main component included in the ceramic material 10 is different from that of the first embodiment. In the fourth embodiment, description of parts common to the first embodiment will be omitted.

### Main Component

The ceramic material 10 includes a compound (oxide) having a perovskite structure as a main component. The ceramic material 10 of the third embodiment includes a compound having a perovskite structure represented by the chemical formula A0(B1ᵥ, B4₁₋ᵥ)O_{w} as a main component. That is, it can be said that the compound as the main component is an oxide in which the element A0 is located at the A site in the perovskite structure, the element B1 or the element B4 is located at the B site in the perovskite structure, and O is located at the O site in the perovskite structure.

Here, the main component may indicate that the content rate of the component is more than 50% in terms of mass ratio with respect to the entire ceramic material 10. In the ceramic material 10, the content rate of the main component is preferably 90% or more and 100% or less, and more preferably 95% or more and 100% or less in terms of mass ratio with respect to the entire ceramic material 10.

### Element A0

A0 in A0(B1ᵥ, B4₁₋ᵥ)O_{w} is an element located at the A site in the perovskite structure. In the fourth embodiment, the element A0 includes Sr and includes at least one of K, Na, La, Gd, and Yb. That is, the element A0 may include Sr and one of K, Na, La, Gd, and Yb, or may include Sr and two or more of K, Na, La, Gd, and Yb.

A high refractive index property and a high transmittance property to visible light can be appropriately secured by including Sr in the element A0. However, when the element A0 includes Sr, defects may occur during sintering, resulting in a decrease in transmittance. In response to this, by substituting a part of the A site with La, Gd, Yb, K, or Na, a decrease in transmittance can be prevented.

The content of Sr with respect to the entire element A0 is preferably 50% or more, more preferably 60.0% or more and 99.5% or less, and still more preferably 70% or more and 99.5% or less in terms of molar ratio. A high refractive index property and a high transmittance property to visible light can be appropriately secured by setting the content of Sr within this range.

The content of K, Na, La, Gd, and Yb with respect to the entire element A0 is preferably 0.5% or more and 50% or less, more preferably 0.5% or more and 40% or less, more preferably 0.5% or more and 30% or less, and still more preferably 0.5% or more and 20% or less in terms of molar ratio. Here, the content of K, Na, La, Gd, and Yb refers to the total content of K, Na, La, Gd, and Yb included in the element A0, and refers to the total content of K, Na, La, Gd, and Yb when the element A0 includes all of K, Na, La, Gd, and Yb, and refers to the content of some components included when the element A0 includes only some of K, Na, La, Gd, and Yb. By setting the content within this range, a decrease in transmittance can be suitably prevented.

The element A0 may include an element other than Sr, K, Na, La, Gd, and Yb. Examples of an element other than Sr, K, Na, La, Gd, and Yb include Ba.

### Element B1

Since the element B1 in the fourth embodiment is the same as the element B1 in the first embodiment, the description thereof will be omitted.

### Element B4

Since the element B4 in the fourth embodiment is the same as the element B4 in the third embodiment, the description thereof will be omitted.

### Numerical Value v

v in A0(B1ᵥ, B4₁₋ᵥ)O_{w} is a numerical value indicating a ratio (molar ratio) of the content of the element B1 to the content of the element B4, and more specifically, is a molar ratio of the content of the element B1 to the total content of the element B1 and the element B4.

The numerical value v is a positive number less than 1. The numerical value v is preferably set so that the average valence of the element B1 and the element B4 is 4. It can also be said that the types of the element B1 and the element B4 and the numerical value v are preferably set so that the average valence of the element B1 and the element B4 is 4.

The numerical value v is preferably 0.5 or more and 1 or less, more preferably 0.7 or more and 1 or less, more preferably 0.8 or more and 1 or less, and still more preferably 0.9 or more and 1 or less. When the numerical value v falls within this range, the ratio of the element B1 to the element B4 can be made appropriate, and a high refractive index property and a high transmittance property to visible light can be appropriately secured.

### Numerical Value w

w in A0(B1ᵥ, B4₁₋ᵥ)O_{w} is a numerical value indicating the content (molar ratio) of O, and more specifically, is a molar ratio of the content of O to the total content of the element A0, the element B1, the element B4, and O. The numerical value w is a numerical value in which the charge neutrality of the entire chemical formula (A0(B1ᵥ, B4₁₋ᵥ)O_{w}) is established, and may be, for example, 3.

### Preferred Examples of Main Component

Preferred examples of the compound represented by A0(B1ᵥ, B4₁₋ᵥ)O_{w} in the fourth embodiment include A0(Tiᵥ, Ta₁₋ᵥ)O_{w}, A0(Tiᵥ, Nb₁₋ᵥ)O_{w}, A0(Tiᵥ, Al₁₋ᵥ)O_{w}, A0(Tiᵥ, Sc₁₋ᵥ)O_{w}, A0(Tiᵥ, Y₁₋ᵥ)O_{w}, and A0(Tiᵥ, Zn₁₋ᵥ)O_{w}. Here, A0 is preferably Sr and La, Sr and Gd, or Sr, La, and Gd.

### Sub-Component

The ceramic material 10 according to the fourth embodiment also preferably has a sub-component derived from the sintering aid as in the first embodiment. The ceramic material 10 according to the fourth embodiment also preferably has an auxiliary component as in the first embodiment. Preferred compositions and contents of the sub-component and the auxiliary component are the same as those in the first embodiment, and thus the description thereof will be omitted.

Note that the ceramic material 10 according to the fourth embodiment may contain any component as an inevitable impurity in addition to the main component, the sub-component, and the auxiliary component described above. The ceramic material 10 according to the fourth embodiment preferably does not have components other than the main component, the sub-component, and the auxiliary component, except for an inevitable impurity.

### Characteristics of Ceramic Material

Since the characteristics of the ceramic material 10 according to the fourth embodiment are the same as the characteristics of the ceramic material 10 according to the first embodiment, the description thereof will be omitted.

### Method for Producing Ceramic Material

The ceramic material 10 according to the fourth embodiment may be produced by any method. An example of the method for producing the ceramic material 10 according to the fourth embodiment is the same as the example of the method for producing the ceramic material 10 according to the first embodiment, and thus the description thereof will be omitted. However, the fourth embodiment is different from the first embodiment in that a main raw material including elements A0 and B4 instead of the elements A and B3 is prepared.

As described above, the ceramic material 10 according to the fourth embodiment includes, as a main component, a compound having a perovskite structure represented by the chemical formula A0(B1ᵥ, B4₁₋ᵥ)O_{w}. The ceramic material 10 of the present embodiment includes a compound having a perovskite structure in which the element A0 including Sr is at the A site and the element B1 is at the B site, and thus has a high refractive index to visible light. In addition, since the ceramic material 10 includes such a compound having a perovskite structure, the ceramic material 10 forms a polycrystalline cubic crystal, and has a high transmittance to visible light. Furthermore, by substituting a part of the A site with K, Na, La, Gd, Yb, or the like, and substituting a part of the B site with the element B4, a decrease in transmittance can be prevented, and a high refractive index and a high transmittance property can be secured.

### Effects

As described above, the ceramic material 10 according to the first aspect of the present disclosure includes, as a main component, a compound having a perovskite structure represented by the chemical formula A(B1ᵥ, B2₁₋ᵥ)O_{w}, in which the element A is at least one or more selected from Ba, Sr, Ca, K, Na, La, Gd, and Yb, the element B1 is at least one or more selected from Ti and Hf, the element B2 is at least one or more selected from Ta, Nb, Zr, Ge, Gd, Yb, Ga, Ca, and Al, the perovskite structure does not have Mg, Zn, Y, and In, v is a positive number less than 1, and w is a numerical value in which the charge neutrality of the entire chemical formula is established. According to the present disclosure, visible light can be transmitted while being appropriately refracted.

A ceramic material 10 according to a second aspect of the present disclosure includes, as a main component, a compound having a perovskite structure represented by the chemical formula A(B1ᵥ, B3₁₋ᵥ)O_{w}, in which the element A is at least one or more selected from Ba, Sr, Ca, La, K, Na, Gd, and Yb, the element B1 is at least one or more selected from Ti, Hf, Ge, and Zr, the element B3 is at least one or more selected from Sc, Y, Zn, Yb, and Al, the perovskite structure does not have Ta and Nb, v is a positive number less than 1, and w is a numerical value in which the charge neutrality of the entire chemical formula is established. According to the present disclosure, visible light can be transmitted while being appropriately refracted.

A ceramic material 10 according to a third aspect of the present disclosure includes, as a main component, a compound having a perovskite structure represented by the chemical formula A(Tiₓ, B5ᵥ, B4₁₋ᵥ₋ₓ)O_{w}, in which the element A is at least one or more selected from Ba, Sr, Ca, K, Na, La, Gd, and Yb, the element B5 is at least one or more selected from Hf, Ge, and Zr, the element B4 is at least one or more selected from Ta, Nb, Al, Sc, Y, and Zn, x is 0.7 or more and 1.0 or less, v is 0 or more and 0.3 or less, x+v≤1.0, and w is a numerical value in which the charge neutrality of the entire chemical formula is established, and the ceramic material 10 has a converted internal transmittance at a thickness of 1 mm with respect to light having a wavelength of 635 nm of 5% or more. According to the present disclosure, visible light can be transmitted while being appropriately refracted.

A ceramic material 10 according to a fourth aspect of the present disclosure is the ceramic material 10 according to the third aspect, and preferably has a converted internal transmittance with respect to light having a wavelength of 635 nm at a thickness of 1 mm of 15% or more. According to the present disclosure, visible light can be transmitted while being appropriately refracted.

A ceramic material 10 according to a fifth aspect of the present disclosure includes, as a main component, a compound having a perovskite structure represented by the chemical formula A0(B1ᵥ, B4₁₋ᵥ)O_{w}, in which the element A0 includes Sr and includes at least one of K, Na, La, Gd, and Yb, the element B1 is at least one or more selected from Ti, Hf, Ge, and Zr, the element B4 is at least one or more selected from Ta, Nb, Al, Sc, Y, and Zn, v is a positive number less than 1, and w is a numerical value in which the charge neutrality of the entire chemical formula is established. According to the present disclosure, visible light can be transmitted while being appropriately refracted.

The ceramic material 10 according to a sixth aspect of the present disclosure is the ceramic material 10 according to any one of the first to fifth aspects, and preferably includes at least one or more selected from Li, Si, B, and Mg as a sub-component. According to the present disclosure, the ceramic material 10 having a high refractive index and a high transmittance property can be appropriately produced since the ceramic material 10 includes such a sub-component.

A ceramic material 10 according to a seventh aspect of the present disclosure is the ceramic material 10 according to the sixth aspect, and the content of the sub-component is preferably 50 ppm or more and 50,000 ppm or less in terms of mass ratio with respect to the entire ceramic material 10. According to the present disclosure, the ceramic material 10 having a high refractive index and a high transmittance property can be appropriately produced by setting the content of the sub-component within this range.

A ceramic material 10 according to an eighth aspect of the present disclosure is the ceramic material 10 according to any one of the first to seventh aspects, and has an internal transmittance with respect to light having a wavelength of 635 nm per 1 mm of material thickness of preferably 5% or more. According to the present disclosure, visible light can be appropriately transmitted.

A ceramic material 10 according to a ninth aspect of the present disclosure is the ceramic material 10 according to any one of the first to eighth aspects, and preferably has a refractive index with respect to light having a wavelength of 635 nm of 2.3 or more. According to the present disclosure, visible light can be appropriately refracted.

A ceramic material 10 according to a tenth aspect of the present disclosure is the ceramic material 10 according to any one of the first to ninth aspects, and preferably has a ratio of the fracture toughness value K_{IC} to the fracture toughness value K_{IC} of SrTiO₃ of the single crystal material of 1.05 or more. According to the present disclosure, damage to the ceramic material 10 can be appropriately prevented.

A ceramic material 10 according to an eleventh aspect of the present disclosure is the ceramic material 10 according to any one of the first to tenth aspects, and preferably has a Vickers hardness of 500 HV or more. According to the present disclosure, damage to the ceramic material 10 can be appropriately prevented.

An optical member according to a twelfth aspect of the present disclosure includes the ceramic material 10 according to any one of the first to eleventh aspects as a light guide plate. According to the present disclosure, visible light can be transmitted while being appropriately refracted.

A head mounted display according to a thirteenth aspect of the present disclosure includes the ceramic material 10 according to any one of the first to twelfth aspects as a light guide plate member. According to the present disclosure, visible light can be transmitted while being appropriately refracted.

In a production method according to a fourteenth aspect of the present disclosure, the ceramic material 10 according to any one of the first to twelfth aspects is produced by the green compact molding method or the cast molding method. According to the present disclosure, a ceramic material capable of transmitting visible light while appropriately refracting the visible light can be appropriately produced.

In a production method according to a fifteenth aspect of the present disclosure, a transparent ceramic body having a refractive index at a wavelength of 635 nm of 2.30 or more is produced by the green compact molding method or the cast molding method. According to the present disclosure, a ceramic material capable of transmitting visible light while appropriately refracting the visible light can be appropriately produced.

### EXAMPLES

Next, examples will be described. The embodiment may be changed as long as the effect of the invention is obtained.

Tables 1 to 12 are tables showing ceramic materials of each example and evaluation results thereof.

TABLE 1

| | Example 1 | Example 2 | Example 3 | Example 4 |
|---|---|---|---|---|
| Main | SrTi_{0.995}Zr_{0.005}O_{w} | SrTi_{0.99}Zr_{0.01}O_{w} | SrTi_{0.995}Ge_{0.005}O_{w} | SrTi_{0.995}Al_{0.005}O_{w} |
| component | | | | |
| Refractive index | 2.36 | 2.36 | 2.36 | 2.36 |
| 635 nm | | | | |
| Converted | 46% | 41% | 61% | 8% |
| internal | | | | |
| transmittance | | | | |
| at thickness of | | | | |
| 1 mm (%) | | | | |
| 635 nm | | | | |
| Fracture | 1.51 | 1.57 | 1.58 | 1.62 |
| toughness | | | | |
| value KIC | | | | |
| (MPa · m^{0.5}) | | | | |
| JIS 1607 | | | | |
| IF method | | | | |
| Ratio to fracture | 1.14 | 1.18 | 1.19 | 1.22 |
| toughness value | | | | |
| of single crystal | | | | |
| Vickers | 593 | 565 | 559 | 632 |
| hardness | | | | |
| (HV) | | | | |
| Color tone | A | A | A | A |
| evaluation | | | | |

| | Example 5 | Example 6 | Example 7 |
|---|---|---|---|
| Main | SrTi_{0.995}Ta_{0.005}O_{w} | SrTi_{0.995}Nb_{0.005}O_{w} | Sr_{0.995}Yb_{0.005}TiO_{w} |
| component | | | |
| Refractive index | 2.37 | 2.38 | 2.38 |
| 635 nm | | | |
| Converted | 13% | 11% | 68% |
| internal | | | |
| transmittance | | | |
| at thickness of | | | |
| 1 mm (%) | | | |
| 635 nm | | | |
| Fracture | 1.34 | 1.45 | 1.26 |
| toughness | | | |
| value KIC | | | |
| (MPa · m^{0.5}) | | | |
| JIS 1607 | | | |
| IF method | | | |
| Ratio to fracture | 1.01 | 1.09 | 0.95 |
| toughness value | | | |
| of single crystal | | | |
| Vickers | 852 | 786 | 932 |
| hardness | | | |
| (HV) | | | |
| Color tone | A | A | A |
| evaluation | | | |

TABLE 2

| | Example 8 | Example 9 | Example 10 | Example 11 | Example 12 | Example 13 | Example 14 |
|---|---|---|---|---|---|---|---|
| Main | SrTiO₃ | SrTiO₃ | SrTi_{0.999}Al_{0.001}O_{w} | SrTi_{0.999}Ta_{0.001}O_{w} | SrTi_{0.999}Ga_{0.001}O_{w} | SrTi_{0.995}Sc_{0.005}O_{w} | SrTi_{0.99}Mg_{0.01}O_{w} |
| component | (Polycrystal- | (Single | | | | | |
| | line body) | crystal body | | | | | |
| | | 100 faces) | | | | | |
| Refractive | 2.38 | 2.37 | 2.36 | 2.37 | 2.37 | 2.37 | 2.37 |
| index 635 nm | | | | | | | |
| Converted | 3% | 100% | 16% | 17% | 10% | 8% | 6% |
| internal | | | | | | | |
| transmittance | | | | | | | |
| at thickness | | | | | | | |
| of 1 mm (%) | | | | | | | |
| 635 nm | | | | | | | |
| Fracture | 1.47 | 1.33 | 1.53 | 1.30 | 1.53 | 1.70> | 1.62 |
| toughness | | | | | | | |
| value KIC | | | | | | | |
| (MPa · m^{0.5}) | | | | | | | |
| JIS 1607 | | | | | | | |
| IF method | | | | | | | |
| Ratio to | 1.11 | 1 | 1.15 | 0.98 | 1.15 | 1.28> | 1.22 |
| fracture | | | | | | | |
| toughness | | | | | | | |
| value of | | | | | | | |
| single | | | | | | | |
| crystal | | | | | | | |
| Vickers | 886 | 345 | 712 | 847 | 726 | 573 | 632 |
| hardness | | | | | | | |
| (HV) | | | | | | | |
| Color tone | B | — | A | A | A | A | A |
| evaluation | | | | | | | |

TABLE 3

| | Example 15 | Example 16 | Example 17 | Example 18 | Example 19 |
|---|---|---|---|---|---|
| Main | SrTi_{0.995}Zn_{0.005}O_{w} | Sr_{0.995}Na_{0.005}Ti_{0.995}Ge_{0.005}O_{w} | Sr_{0.99}Yb_{0.01}TiO_{w} | Sr_{0.995}Yb_{0.005}Ti_{0.99}Ge_{0.01}O_{w} | Sr_{0.99}Yb_{0.01}Ti_{0.995}Zr_{0.005}O_{w} |
| component | | | | | |
| Refractive index | 2.38 | 2.37 | 2.38 | 2.38 | 2.38 |
| 635 nm | | | | | |
| Converted | 6% | 15% | 78% | 19% | 43% |
| internal | | | | | |
| transmittance | | | | | |
| at thickness of | | | | | |
| 1 mm (%) | | | | | |
| 635 nm | | | | | |
| Fracture | 1.61 | 1.63 | 1.61 | 1.61 | 0.95 |
| toughness | | | | | |
| value KIC | | | | | |
| (MPa · m^{0.5}) | | | | | |
| JIS 1607 | | | | | |
| IF method | | | | | |
| Ratio to fracture | 1.21 | 1.23 | 1.21 | 1.21 | 0.71 |
| toughness value | | | | | |
| of single crystal | | | | | |
| Vickers | 605 | 854 | 813 | 813 | 890 |
| hardness | | | | | |
| (HV) | | | | | |
| Color tone | A | A | A | A | B |
| evaluation | | | | | |

TABLE 4

| | Example 20 | Example 21 | Example 22 | Example 23 |
|---|---|---|---|---|
| Main | Sr_{0.99}Yb_{0.01}Ti_{0.999}Ta_{0.001}O_{w} | Sr_{0.99}Yb_{0.01}Ti_{0.995}Nb_{0.005}O_{w} | Sr_{0.985}Ca_{0.010}Yb_{0.005} | Sr_{0.96}Ca_{0.03}Yb_{0.01} |
| component | | | Ti_{0.99}Ge_{0.01}O_{w} | Ti_{0.995}Zr_{0.005}O_{w} |
| Refractive index | 2.38 | 2.38 | 2.38 | 2.37 |
| 635 nm | | | | |
| Converted | 36% | 25% | 33% | 12% |
| internal | | | | |
| transmittance | | | | |
| at thickness of | | | | |
| 1 mm (%) | | | | |
| 635 nm | | | | |
| Fracture | 1.51 | 1.48 | 1.54 | 1.55 |
| toughness | | | | |
| value KIC | | | | |
| (MPa · m^{0.5}) | | | | |
| JIS 1607 | | | | |
| IF method | | | | |
| Ratio to fracture | 1.14 | 1.1 | 1.16 | 1.16 |
| toughness value | | | | |
| of single crystal | | | | |
| Vickers | 620 | 674 | 633 | 599 |
| hardness | | | | |
| (HV) | | | | |
| Color tone | A | A | A | A |
| evaluation | | | | |

TABLE 5

| | Example 24 | Example 25 | Example 26 | Example 27 |
|---|---|---|---|---|
| Main | Sr_{0.985}Ca_{0.005}Yb_{0.010}Ti_{0.99}Ge_{0.01}O_{w} | Sr_{0.96}Ca_{0.03}Gd_{0.01}TiO_{w} | Sr_{0.985}Gd_{0.015}Ti_{0.995}Zr_{0.005}O_{w} | Sr_{0.98}Ca_{0.01}Gd_{0.01}Ti_{0.995}Zr_{0.005}O_{w} |
| component | | | | |
| Refractive index | 2.38 | 2.37 | 2.37 | 2.37 |
| 635 nm | | | | |
| Converted | 10% | 13% | 11% | 12% |
| internal | | | | |
| transmittance | | | | |
| at thickness of | | | | |
| 1 mm (%) | | | | |
| 635 nm | | | | |
| Fracture | 1.55 | 1.69 | 1.63 | 1.56 |
| toughness | | | | |
| value KIC | | | | |
| (MPa · m^{0.5}) | | | | |
| JIS 1607 | | | | |
| IF method | | | | |
| Ratio to fracture | 1.16 | 1.27 | 1.23 | 1.17 |
| toughness value | | | | |
| of single crystal | | | | |
| Vickers | 575 | 693 | 648 | 624 |
| hardness | | | | |
| (HV) | | | | |
| Color tone | A | A | A | A |
| evaluation | | | | |

TABLE 6

| | Example 28 | Example 29 | Example 30 | Example 31 |
|---|---|---|---|---|
| Main | Sr_{0.97}Ca_{0.02}Gd_{0.01}Ti_{0.995}Zr_{0.005}O_{w} | Sr_{0.95}Ca_{0.04}Gd_{0.01}Ti_{0.995}Zr_{0.005}O_{w} | Sr_{0.94}Ca_{0.05}Gd_{0.01} | Sr_{0.93}Ca_{0.06}Gd_{0.01} |
| component | | | Ti_{0.995}Zr_{0.005}O_{w} | Ti_{0.995}Zr_{0.005}O_{w} |
| Refractive index | 2.37 | 2.37 | 2.35 | 2.34 |
| 635 nm | | | | |
| Converted | 5% | 6% | 16% | 15% |
| internal | | | | |
| transmittance | | | | |
| at thickness of | | | | |
| 1 mm (%) | | | | |
| 635 nm | | | | |
| Fracture | 1.58 | 1.54 | 1.47 | 1.47 |
| toughness | | | | |
| value KIC | | | | |
| (MPa · m^{0.5}) | | | | |
| JIS 1607 | | | | |
| IF method | | | | |
| Ratio to fracture | 1.18 | 1.16 | 1.11 | 1.11 |
| toughness value | | | | |
| of single crystal | | | | |
| Vickers | 599 | 694 | 578 | 578 |
| hardness | | | | |
| (HV) | | | | |
| Color tone | A | A | A | A |
| evaluation | | | | |

TABLE 7

| | Example 32 | Example 33 | Example 34 | Example 35 | Example 36 |
|---|---|---|---|---|---|
| Main | Sr_{0.84}Ba_{0.10}Ca_{0.05}Gd_{0.01}TiO_{w} | Sr_{0.84}Ba_{0.10}Ca_{0.05}Gd_{0.01} | Sr_{0.99}Gd_{0.01} | Sr_{0.99}Gd_{0.01}TiO_{w} | Sr_{0.99}La_{0.01} |
| component | | Ti_{0.995}Ge_{0.005}O_{w} | Ti_{0.995}Zr_{0.005}O_{w} | | Ti_{0.995}Zr_{0.005}O_{w} |
| Refractive index | 2.38 | 2.38 | 2.38 | 2.38 | 2.38 |
| 635 nm | | | | | |
| Converted | 16% | 46% | 45% | 62% | 12% |
| internal | | | | | |
| transmittance | | | | | |
| at thickness of | | | | | |
| 1 mm (%) | | | | | |
| 635 nm | | | | | |
| Fracture | 1.62 | 1.57 | 1.62 | 1.47 | 1.60 |
| toughness | | | | | |
| value KIC | | | | | |
| (MPa · m^{0.5}) | | | | | |
| JIS 1607 | | | | | |
| IF method | | | | | |
| Ratio to fracture | 1.22 | 1.18 | 1.22 | 1.11 | 1.20 |
| toughness value | | | | | |
| of single crystal | | | | | |
| Vickers | 709 | 732 | 606 | 886 | 604 |
| hardness | | | | | |
| (HV) | | | | | |
| Color tone | A | A | A | A | A |
| evaluation | | | | | |

TABLE 8

| | Example 37 | Example 38 | Example 39 | Example 40 | Example 41 |
|---|---|---|---|---|---|
| Main | Sr_{0.99}Gd_{0.01}Ti_{0.994} | Sr_{0.95}Ca_{0.05} | Sr_{0.96}Ca_{0.04}TiO_{w} | Sr_{0.75}Ba_{0.21}Ca_{0.04} | Sr_{0.90}Ba_{0.10} |
| component | Zr_{0.005}Nb_{0.001}O_{w} | Ti_{0.995}Ge_{0.005}O_{w} | | Ti_{0.995}Ge_{0.005}O₃ | Ti_{0.995}Ge_{0.005}O_{w} |
| Refractive index | 2.38 | 2.35 | 2.36 | 2.38 | 2.37 |
| 635 nm | | | | | |
| Converted | 17% | 13% | 54% | 23% | 18% |
| internal | | | | | |
| transmittance | | | | | |
| at thickness of | | | | | |
| 1 mm (%) | | | | | |
| 635 nm | | | | | |
| Fracture | 1.65 | 1.49 | 1.54 | 1.52 | 1.49 |
| toughness | | | | | |
| value KIC | | | | | |
| (MPa · m^{0.5}) | | | | | |
| JIS 1607 | | | | | |
| IF method | | | | | |
| Ratio to fracture | 1.24 | 1.12 | 1.01 | 1.14 | 1.12 |
| toughness value | | | | | |
| of single crystal | | | | | |
| Vickers | 713 | 632 | 691 | 665 | 629 |
| hardness | | | | | |
| (HV) | | | | | |
| Color tone | A | A | A | A | A |
| evaluation | | | | | |

TABLE 9

| | Example 42 | Example 43 | Example 44 | Example 45 | Example 46 | Example 47 | Example 48 |
|---|---|---|---|---|---|---|---|
| Main | Sr_{0.80}Ba_{0.20} | Sr_{0.99} | Sr_{0.995} | Sr_{0.99} | Sr_{0.995} | Sr_{0.95} | Sr_{0.95} |
| component | Ti_{0.995}Ge_{0.005}O_{w} | Na_{0.01}TiO_{w} | Na_{0.005}TiO_{w} | K_{0.01}TiO_{w} | K_{0.005}TiO_{w} | Ca_{0.005}TiO_{w} | Mg_{0.005}TiO_{w} |
| Refractive index | 2.38 | — | — | — | — | — | — |
| 635 nm | | | | | | | |
| Converted | 13% | <0.5% | <0.5% | <0.5% | <0.5% | <0.5% | <0.5% |
| internal | | | | | | | |
| transmittance | | | | | | | |
| at thickness of | | | | | | | |
| 1 mm (%) | | | | | | | |
| 635 nm | | | | | | | |
| Fracture | 1.45 | — | — | — | — | | — |
| toughness | | | | | | | |
| value KIC | | | | | | | |
| (MPa · m^{0.5}) | | | | | | | |
| JIS 1607 | | | | | | | |
| IF method | | | | | | | |
| Ratio to fracture | 1.09 | — | — | — | — | | — |
| toughness value | | | | | | | |
| of single crystal | | | | | | | |
| Vickers | 613 | — | — | — | — | | — |
| hardness | | | | | | | |
| (HV) | | | | | | | |
| Color tone | A | A | A | A | A | A | A |
| evaluation | | | | | | | |

TABLE 10

| | Example 49 | Example 50 | Example 51 | Example 52 | Example 53 |
|---|---|---|---|---|---|
| Main | Sr_{0.60}Ba_{0.40}TiO_{w} | Sr_{0.99}Gd_{0.01} | Sr_{0.995}Gd_{0.005} | Sr_{0.95}Gd_{0.05} | Sr_{0.90}Gd_{0.10} |
| component | | Ti_{0.99}Al_{0.01}O_{w} | Ti_{0.995}Al_{0.005}O_{w} | Ti_{0.95}Al_{0.05}O_{w} | Ti_{0.90}Al_{0.10}O_{w} |
| Refractive index | — | — | — | — | — |
| 635 nm | | | | | |
| Converted | <0.5% | <0.5% | <0.5% | <0.5% | <0.5% |
| internal | | | | | |
| transmittance | | | | | |
| at thickness of | | | | | |
| 1 mm (%) | | | | | |
| 635 nm | | | | | |
| Fracture | | — | — | — | — |
| toughness | | | | | |
| value KIC | | | | | |
| (MPa · m^{0.5}) | | | | | |
| JIS 1607 | | | | | |
| IF method | | | | | |
| Ratio to fracture | | — | — | — | — |
| toughness value | | | | | |
| of single crystal | | | | | |
| Vickers | | — | — | — | — |
| hardness | | | | | |
| (HV) | | | | | |
| Color tone | A | A | A | A | A |
| evaluation | | | | | |

TABLE 11

| | Example 54 | Example 55 | Example 56 | Example 57 | Example 58 |
|---|---|---|---|---|---|
| Main | Sr_{0.99}Yb_{0.01} | Sr_{0.995}Yb_{0.005} | Sr_{0.99}Yb_{0.01} | Sr_{0.99}Yb_{0.01} | Sr_{0.99}La_{0.01}TiO_{w} |
| component | Ti_{0.99}Al_{0.01}O_{w} | Ti_{0.995}Al_{0.005}O_{w} | Ti_{0.995}Ta_{0.005}O_{w} | Ti_{0.99}Nb_{0.01}O_{w} | |
| Refractive index | — | — | — | — | — |
| 635 nm | | | | | |
| Converted | <0.5% | <0.5% | <0.5% | <0.5% | <0.5% |
| internal | | | | | |
| transmittance | | | | | |
| at thickness of | | | | | |
| 1 mm (%) | | | | | |
| 635 nm | | | | | |
| Fracture | — | — | — | | — |
| toughness | | | | | |
| value KIC | | | | | |
| (MPa · m^{0.5}) | | | | | |
| JIS 1607 | | | | | |
| IF method | | | | | |
| Ratio to fracture | — | — | — | | — |
| toughness value | | | | | |
| of single crystal | | | | | |
| Vickers | — | — | — | | — |
| hardness | | | | | |
| (HV) | | | | | |
| Color tone | A | A | A | A | A |
| evaluation | | | | | |

TABLE 12

| | Example 59 | Example 60 | Example 61 |
|---|---|---|---|
| Main | Sr_{0.995}La_{0.005}Ti_{0.995}Al_{0.005}O_{w} | Sr_{0.98}Yb_{0.01}Gd_{0.01}TiO₃ | Sr_{0.98}La_{0.01}Gd_{0.01}TiO_{w} |
| component | | | |
| Refractive index | — | — | — |
| 635 nm | | | |
| Converted | <0.5% | <0.5% | <0.5% |
| internal | | | |
| transmittance | | | |
| at thickness of | | | |
| 1 mm (%) | | | |
| 635 nm | | | |
| Fracture | — | — | — |
| toughness | | | |
| value KIC | | | |
| (MPa · m^{0.5}) | | | |
| JIS 1607 | | | |
| IF method | | | |
| Ratio to fracture | — | — | — |
| toughness value | | | |
| of single crystal | | | |
| Vickers | — | — | — |
| hardness | | | |
| (HV) | | | |
| Color tone | B | B | B |
| evaluation | | | |

### Example 1

In Example 1, strontium carbonate, titanium oxide, and aluminum oxide powder were prepared as main raw materials, and SiO₂ powder was prepared as a sub-raw material (sintering aid). The main raw materials were blended in a stoichiometric ratio such that SrTi_{0.995}Zr_{0.005}O₃ was obtained. The average particle size of the raw material measured with a particle size distribution measuring device (Shimadzu Corporation: SALD-2300) was 0.1 to 2.0 μm.

Each raw material was wet-mixed under the condition of ball mill mixing for 2 hours using alumina balls as grinding media, then the raw material after mixing was subjected to a drying treatment under the condition of holding at 80° C. for 10 hours, and the raw material after drying was subjected to a carbon removal treatment under the condition of holding at 1050° C. for 10 hours.

A binder (PVA aqueous solution, prepared from a raw material manufactured by KANTO CHEMICAL CO., INC.) was added to the raw material subjected to the carbon removal treatment to obtain a raw material slurry. The obtained raw material slurry was dried under the condition of 80° C. and 10 hours, and a molded body was obtained using uniaxial pressing and a CIP method. The obtained molded body was subjected to a degreasing treatment under the condition of being held at 900° C. for 5 hours.

The molded body after the degreasing treatment was subjected to a sintering treatment under the condition of 2 atm of oxygen and 1500° C., and then subjected to a HIP treatment under the condition of holding at 1350° C. for 1 hour in an Ar atmosphere at 150 MPa, and subjected to an annealing treatment of holding at 1000° C. for 6 hours in an air atmosphere to obtain a ceramic material of Example 1.

As shown in Table 1, the composition of the main component (compound having a perovskite structure) of the ceramic material of Example 1 was SrTi_{0.995}Zr_{0.005}O₃, the composition of the sub-component was SiOₓ, and the content of the sub-component was 5,000 ppm.

The refractive index and the converted internal transmittance with respect to light having a wavelength of 635 nm and the color tone evaluation of the ceramic material of Example 1 were measured. The method described in the present embodiment was used as a measurement condition. The measurement results of the refractive index and the converted internal transmittance are shown in Table 1.

### Examples 2 to 8

In Examples 2 to 8, ceramic materials were obtained in the same manner as in Example 1 except for the conditions of the raw material composition, the sub-raw material, and the auxiliary raw material. In Example 3, a main raw material was prepared so as to have a stoichiometric ratio of SrTi_{0.995}Ge_{0.005}O₃, and SrTi_{0.995}Ge_{0.005}O₃ was obtained as a main component. In Example 4, a main raw material was prepared so as to have a stoichiometric ratio of SrTi_{0.995}Al_{0.005}O₃, and SrTi_{0.995}Al_{0.005}O₃ was obtained as a main component. In Example 5, a main raw material was prepared so as to have a stoichiometric ratio of SrTi_{0.995}Ta_{0.005}O₃, and SrTi_{0.995}Ta_{0.005}O₃ was obtained as a main component. In Example 6, a main raw material was prepared so as to have a stoichiometric ratio of SrTi_{0.995}Nb_{0.005}O₃, and SrTi_{0.995}Nb_{0.005}O₃ was obtained as a main component. In Example 7, a main raw material was prepared so as to have a stoichiometric ratio of Sr_{0.995}Yb_{0.005}TiO₃, and Sr_{0.995}Yb_{0.005}TiO₃ was obtained as a main component. In Example 8, a main raw material was prepared so as to have a stoichiometric ratio of SrTiO₃, and SrTiO₃ having a polycrystalline body was obtained as a main component.

The measurement results of the composition of the main component, the composition and the content of the sub-component, the refractive index and the converted internal transmittance, and the color tone evaluation of the ceramic material of each example are shown in the table.

### Example 9

In Example 9, the measurement evaluation results of the SrTiO₃ single crystal material are shown for comparison with the ceramic material in the refractive index and the Vickers hardness test.

### Examples 10 to 42

In Examples 10 to 42, ceramic materials were obtained in the same manner as in Examples 1 to 8 except for the conditions of the raw material composition, the sub-raw material, and the auxiliary raw material. Examples 1 to 7 and 10 to 42 are examples, Example 8 is a comparative example, and Example 9 is a reference example.

### Examples 17, 32 to 35, 37, and 38

A ceramic material was obtained in the same manner except that the molded body after the degreasing treatment in Example 1 was subjected to a sintering treatment under the condition of 2 atm of oxygen and 1450° C., subjected to a HIP treatment under the condition of holding at 1350° C. for 1 hour in an Ar atmosphere at 150 MPa, and subjected to annealing in an air atmosphere at 1100° C.

### Examples 18 to 31, and 36

A ceramic material was obtained in the same manner except that the molded body after the degreasing treatment in Example 1 was subjected to a sintering treatment under the condition of 2 atm of oxygen and 1450° C., subjected to a HIP treatment under the condition of holding at 1350° C. for 1 hour in an Ar atmosphere at 150 MPa.

### Examples 43 to 61

In Examples 43 to 61, ceramic materials were obtained in the same manner as in Examples 1 to 8 and Examples 10 to 42 except for the conditions of the raw material composition, the sub-raw material, and the auxiliary raw material. Examples 43 to 61 are comparative examples to Examples 10 to 42. Various sintering conditions and HIP conditions were examined, but translucency could not be obtained.

### Evaluation

In the evaluation, refractive index evaluation, transmittance evaluation, Vickers hardness, and color tone evaluation were performed. In the converted internal transmittance evaluation, the internal transmittance at a thickness of 1 mm was evaluated, and when the evaluation was possible, the numerical values were described in each table. In the evaluation of the color tone, the case where the appearance was white was evaluated as A (good), and the case where the appearance was colored was evaluated as B (acceptable). Representative materials are evaluated by the Vickers hardness and the fracture toughness evaluation (IF method).

According to the present invention, visible light can be transmitted while being appropriately refracted.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A ceramic material comprising, as a main component, a compound having a perovskite structure represented by a chemical formula A(B1ᵥ, B2₁₋ᵥ)O_{w},
wherein
the A is at least one or more selected from Ba, Sr, Ca, K, Na, La, Gd, and Yb,
the B1 is at least one or more selected from Ti and Hf,
the B2 is at least one or more selected from Ta, Nb, Zr, Ge, Gd, Yb, Ga, Ca, and Al,
the perovskite structure does not have Mg, Zn, Y, and In,
v is a positive number less than 1, and w is a numerical value in which a charge neutrality of an entire chemical formula is established.

2. A ceramic material comprising, as a main component, a compound having a perovskite structure represented by a chemical formula A(B1ᵥ, B3₁₋ᵥ)O_{w},
wherein
the A is at least one or more selected from Ba, Sr, Ca, La, K, Na, Gd, and Yb,
the B1 is at least one or more selected from Ti, Hf, Ge, and Zr,
the B3 is at least one or more selected from Sc, Y, Zn, Yb, and Al,
the perovskite structure does not have Ta and Nb,
v is a positive number less than 1, and w is a numerical value in which a charge neutrality of an entire chemical formula is established.

3. A ceramic material comprising, as a main component, a compound having a perovskite structure represented by a chemical formula A(Tiₓ, B5ᵥ, B4₁₋ᵥ₋ₓ)O_{w},
wherein
the A is at least one or more selected from Ba, Sr, Ca, K, Na, La, Gd, and Yb,
the B5 is at least one or more selected from Hf, Ge, and Zr,
the B4 is at least one or more selected from Ta, Nb, Al, Sc, Y, and Zn,
x is 0.7 or more and 1.0 or less, v is 0 or more and 0.3 or less, x+v≤1.0, and w is a numerical value in which a charge neutrality of an entire chemical formula is established, and
the ceramic material has a converted internal transmittance at a thickness of 1 mm with respect to light having a wavelength of 635 nm of 5% or more.

4. The ceramic material according to claim 3, having a converted internal transmittance at a thickness of 1 mm with respect to light having a wavelength of 635 nm of 15% or more.

5. A ceramic material comprising, as a main component, a compound having a perovskite structure represented by a chemical formula A0(B1ᵥ, B4₁₋ᵥ)O_{w},
wherein
the A0 includes Sr and includes at least one of K, Na, La, Gd, and Yb,
the B1 is at least one or more selected from Ti, Hf, Ge, and Zr,
the B4 is at least one or more selected from Ta, Nb, Al, Sc, Y, and Zn,
v is a positive number less than 1, and w is a numerical value in which a charge neutrality of an entire chemical formula is established.

6. The ceramic material according to claim 1, comprising at least one or more selected from Li, Si, B, and Mg as a sub-component.

7. The ceramic material according to claim 6, comprising the sub-component in a content of 50 ppm or more and 50,000 ppm or less in terms of mass ratio with respect to an entire ceramic material.

8. The ceramic material according to claim 1, having a converted internal transmittance at a thickness of 1 mm with respect to light having a wavelength of 635 nm of 5% or more.

9. The ceramic material according to claim 1, having a refractive index with respect to light having a wavelength of 635 nm of 2.30 or more.

10. The ceramic material according to claim 1, having a ratio of a fracture toughness value K_{IC} to a fracture toughness value K_{IC} of SrTiO₃ of a single crystal material of 1.05 or more.

11. The ceramic material according to claim 1, having a Vickers hardness of 500 HV or more.

12. An optical member comprising the ceramic material according to claim 1 as a light guide plate.

13. A head mounted display comprising the ceramic material according to claim 1 as a light guide plate member.

14. A production method for producing the ceramic material according to claim 1 by a green compact molding method or a cast molding method.

15. A production method for producing a transparent ceramic body having a refractive index at a wavelength of 635 nm of 2.30 or more by a green compact molding method or a cast molding method.
